(19) United States
(12) Patent Application Publication
(10) Pub. No.: US 2008/0016698 A1
(43) Pub. Date: Jan. 24, 2008

(54) Illuminated washable spoon

(76) Inventor: Alfred N. Simpson, Philadelphia, PA (US)

Correspondence Address: Kenneth P. Glynn, 24 Mine Street, Flemington, NJ, 08822, US

(21) Appl. No.: 11/490,509

(22) Filed: Jul. 21, 2006

(51) Int. Cl. A47J 43/28

(52) U.S. Cl. 30/142; 30/324

(57) ABSTRACT

The illuminated washable spoon includes a main spoon body having a concave distal portion and a handle portion. The handle portion is hollow and has a depressible section adapted to depress when the handle portion is held. An illumination mechanism is located within the handle portion. The illumination mechanism includes a power source, an on/off pressure switch and a light. The on/off pressure switch is located at the depressible section of the handle portion such that when the handle portion is held, force toward the handle portion caused by the holder depresses the depressible section, activating the pressure switch and illuminated the light.

### BACKGROUND OF INVENTION

a. Field of Invention

The invention relates generally to washable spoons for infants and toddlers and, more specifically, to plastic washable spoons that light up when child holds the spoon. The handle has a depressible portion that closes a switch to effect illumination.

b. Description of Related Art

The following patents are representative of mechanisms that change in response to consumption activity:

U.S. Pat. No. 6,359,559 to Rudell et al. describes a toy that activates an indicator while an end user consumes an edible substance. The toy includes a first electrode and a second electrode that are connected to the indicator. An electrical path is created between the first and second electrodes while the end user is consuming the consumable substance to close an electrical circuit with the indicator. The closed circuit activates the indicator.

U.S. Pat. No. 6,024,624 to Lee describes a novelty article for use in connection with liquid having a body and a generating mechanism, which is attached to the body, for generating electrically produced special effects, such audible sounds and visible lights, so as to enhance amusement for a user. The generating mechanism is provided with an activating mechanism, which is attached to the body, for activating the generating mechanism in response to contact by liquid. In accordance with one feature of the present invention, the body includes a drinking straw having a passageway for liquid. The activating mechanism has a pair of electrical contacts positioned in the passageway so as to activate the generating mechanism in response to liquid flow through the passageway.

U.S. Pat. No. 5,299,356 to Maxwell, III describes an eating utensil for counting the number of bites the user consumes in accordance with a specific diet plan regulating the fat intake by the user. The eating utensil has an illuminated display which changes de pending on the number of bites consumed by the user. A push button is activated each time the user lifts up a fork full of food from the plate. An associated set of cards carries the names of the food items and the particular number of bites allowed to be taken depending on the fat content of that food item.

Notwithstanding the prior art, the present invention is neither taught nor rendered obvious thereby.

### SUMMARY OF INVENTION

The invention solves the problems and overcomes the drawbacks and deficiencies of prior art baby spoon devices by providing a motivational feature to a washable spoon, namely, illumination when held by the baby or toddler.

The present invention illuminated washable spoon includes a main spoon body having a concave distal portion and a handle portion. The handle portion is hollow and has a depressible section adapted to depress when the handle portion is held. An illumination mechanism is located within the handle portion. The illumination mechanism includes a power source, an on/off pressure switch and a light. The on/off pressure switch is located at the depressible section of the handle portion such that when the handle portion is held, force toward the handle portion caused by the holder depresses the depressible section, activating the pressure switch and illuminates the light.

In some preferred embodiments, the handle portion may include a tail section that is permanently attached to the handle portion. It includes a non-depressible section that has a wall thickness greater than the wall thickness of the depressible section of the handle portion.

In some preferred embodiments the light may be directed toward the concave distal portion and at least part of the handle portion.

In some preferred embodiments, the main spoon body may be at least partially transparent and partially translucent. The main body may also be multi-colored. The main spoon body may be completely translucent.

In some preferred embodiments, the illumination mechanism may include a sounding feature that emits sound simultaneously with illumination of the light. The sound may be a musical tune.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a partially cut side view of an embodiment of an illuminated washable plastic spoon according to the present invention, illustrating its internal functional aspects and components;

FIG. 2 is a partially cut partial side view of another present invention illuminated washable spoon handle portion; and,

FIG. 3 is a schematic diagram of present invention illuminated washable spoon features.

### DETAILED DESCRIPTION OF THE EMBODIMENTS

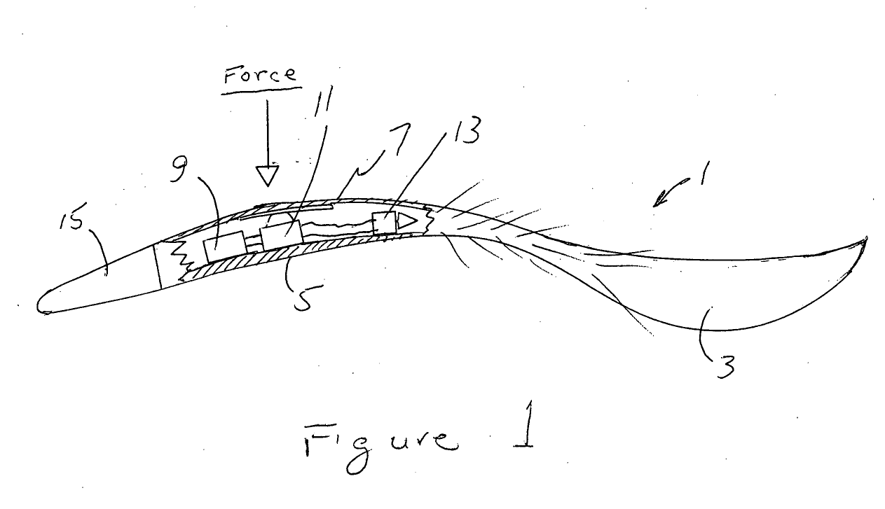

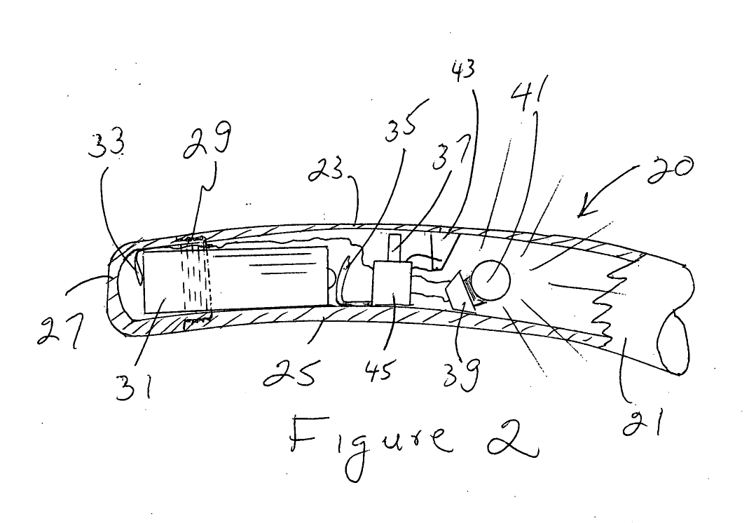

Referring now to the drawings wherein preferred embodiments are presented as examples of the present invention, FIG. 1 shows a partially cut side view of spoon 1. The concave portion 3 also sometimes referred to as the dish or bowl end, has a normal baby spoon shape. Handle portion 5 has a removable tail 15 and is at least partially hollow. Top area 7 of handle portion 5 is depressible and will flex downwardly easily. Thus, when a baby or toddler holds the spoon 1 in a normal closed baby fist position, top area 7 depresses and closes pressure switch 11, causing current from power source 9 to flow into light 13. The light is directed to and flows toward concave portion 3. Concave portion 3 is typically solid, but may be hollow, translucent or transparent and may be clear or colored. If colored, it may be multi-colored or single colored. The handle portion may be the same as the concave portion or different and may have any of the concave section described color and transparency features.

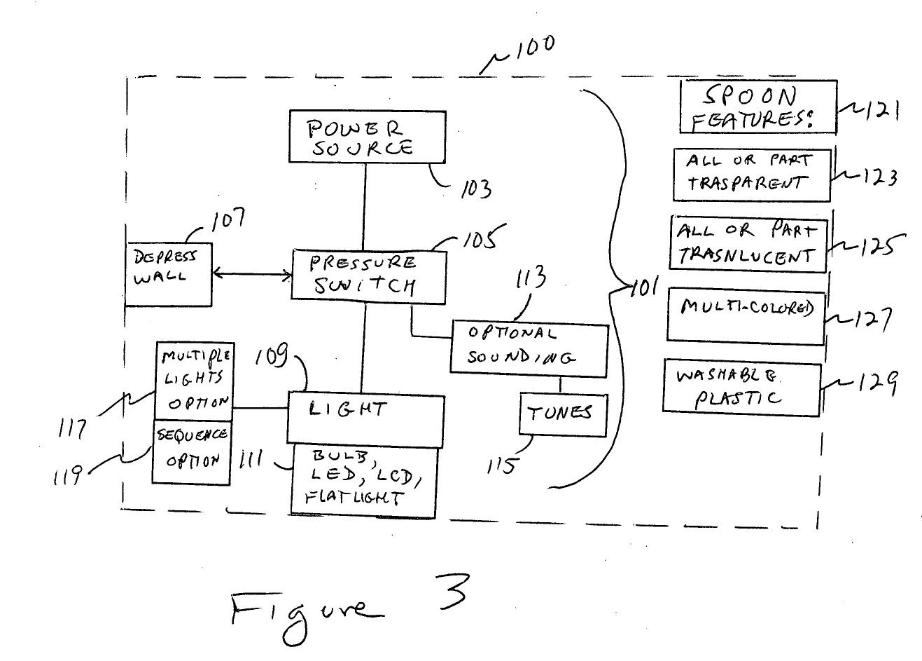

FIG. 2 shows a partially cut partial view of another present invention illuminated washable spoon 20. This embodiment includes a hollow handle portion 21 with a thin depressible area 23 and a stiff bottom 25. It has a removable tail piece 27 with water sealable threads 29. Battery 31 is replaceable and has spring contacts 33 and 35 connected to switch 37, as shown. Switch 37 is a pressure switch and is an open circuit switch in its rest position. It includes a music chip 45 and is connected to bulb receiver 39 and water proof micro speaker 43. When thin depressible area 23 is depressed, it presses switch 37 to close the circuit, thereby illuminating bulb 41 and playing a tune through micro speaker 43. This illuminates at least a part of the spoon to the delight of the user.

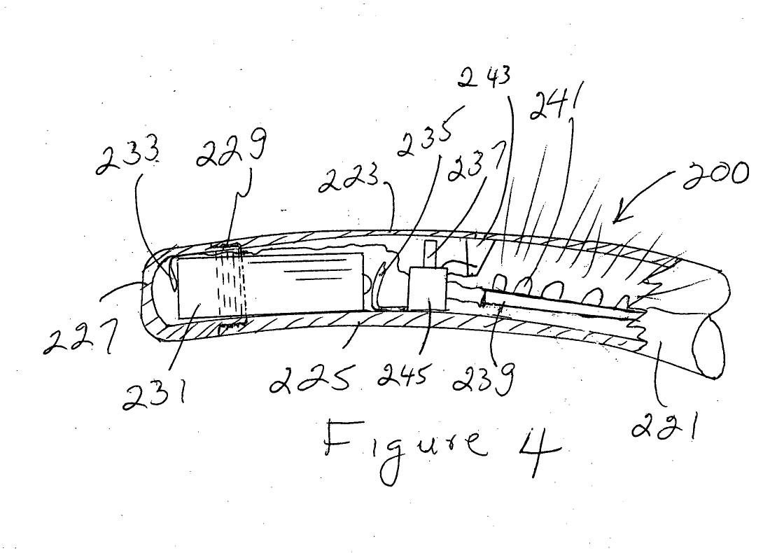

FIG. 3 shows a schematic diagram of various preferred embodiments of present invention spoons represented generally by frame 100. Illumination mechanism 101 involves many features, including power source 103, pressure switch 105, depressible wall 107 and light 109. Illumination mechanism 101 also involves bulb, LED, LCD or flatlight 111; optional sounding 113; tunes 115; multiple lights option 117 and sequence option 119. Spoon features 121 include all or part transparent 123, and/or all or part translucent 125, optionally multi-colored 127, and washable plastic 129. The plastic may be any available plastic or plastics that are acceptable for eating food and will flex at thin areas. Thus, polystyrene, polyethylene, polypropylene, polycarbonate or combinations thereof.

FIG. 4 shows a partially cut partial view of another present invention illuminated washable spoon 200 with multiple light sources. This embodiment includes a hollow handle portion 221 with a thin depressible area 223 and a stiff bottom 225. It has a removable tail piece 227 with water sealable threads 229. Battery 231 is replaceable and has spring contacts 233 and 235 connected to switch 237, as shown. Switch 237 is a pressure switch and is open in its rest position. It includes a music chip 245 and is connected to LED string 239 and water proof micro speaker 243. When thin depressible area 223 is depressed, it presses switch 237 to close the circuit, thereby illuminating the LED's such as LED 241, and playing a tune through micro speaker 243. This illuminates at least a part of the spoon to the delight of the user. In one embodiment, all of the LED's illuminate together continuously. In alternative embodiment they could sequence in a prearranged pattern with a control chip or blink simultaneously.

To summarize, the present invention thus provides a unique eating implement for infants and toddlers that both provides entertainment value to the child and motivational value for the child to eat.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. An illuminated washable spoon which comprises:
a.) a main spoon body having a concave distal portion and having a handle portion, said handle portion being hollow and having a depressible section adapted to depress when said handle portion is held;
b.) an illumination mechanism located within said handle portion, said illumination mechanism including a power source, an on/off pressure switch and a light wherein said on/off pressure switch is located at said depressible section of said handle portion such that when said handle portion is held, force toward the handle portion caused by said holding depresses said depressible section, activating said pressure switch and illuminated said light.

2. The illuminated washable spoon of claim 1 wherein said handle portion includes a tail section that is permanently attached to said handle portion.

3. The illuminated washable spoon of claim 1 wherein said handle portion includes a tail section that is removably attached to said handle portion.

4. The illuminated washable spoon of claim 1 wherein said handle portion includes a non-depressible section having a wall thickness greater than the wall thickness of the depressible section of said handle portion.

5. The illuminated washable spoon of claim 1 wherein said light is directed toward said concave distal portion.

6. The illuminated washable spoon of claim 1 wherein said light is directed toward at least part of said handle portion.

7. The illuminated washable spoon of claim 1 wherein said main spoon body is at least partially transparent.

8. The illuminated washable spoon of claim 1 wherein said main spoon body is completely transparent.

9. The illuminated washable spoon of claim 1 wherein said main spoon body is at least partially translucent.

10. The illuminated washable spoon of claim 1 wherein said main spoon body is multi-colored.

11. The illuminated washable spoon of claim 9 wherein said main spoon body is multi-colored.

12. The illuminated washable spoon of claim 1 wherein said main spoon body is completely translucent.

13. The illuminated washable spoon of claim 12 wherein said main spoon body is multi-colored.

14. The illuminated washable spoon of claim 1 wherein said illumination mechanism further includes a sounding feature that emits sound simultaneously with illumination of said light.

15. The illuminated washable spoon of claim 14 wherein said sound is a musical tune.
